(19) United States
(12) Patent Application Publication
(10) Pub. No.: US 2014/0166052 A1
(43) Pub. Date: Jun. 19, 2014

(54) METHOD AND APPARATUS FOR WASHING AQUATIC ANIMAL CONTAINMENT BASINS

(71) Applicant: IWT S.R.L. (Italian Limited Liability Company), Casale Litta (IT)

(72) Inventor: Michele Vitali, Angera (IT)

(73) Assignee: IWT S.R.L. (Italian Limited Liability Company), Casale Litta (IT)

(21) Appl. No.: 13/962,065

(22) Filed: Aug. 8, 2013

Related U.S. Application Data
(60) Provisional application No. 61/721,292, filed on Nov. 1, 2012.

(51) Int. Cl. B08B 9/093

(52) U.S. Cl. CPC B08B 9/093
USPC 134/22.1; 134/95.1

(57) ABSTRACT

A method for washing one or more tanks for containing aquatic animals includes inserting one or more tanks for aquatic animals to be washed into a washing chamber of a washing apparatus. A washing solution is supplied to the washing chamber and comprises an alkaline detergent in combination with hydrogen peroxide. The alkaline detergent is free from surfactants, phosphates and chlorine. A neutralizing agent is supplied to the washing chamber and also is free from surfactants, phosphates and chlorine, to re-establish a desired pH of the residual washing solution in the washing chamber. Rinsing water is supplied to the washing chamber to rinse the tanks

This application claims the benefit of U.S. Provisional Patent Application Ser. No. 61/721,292, filed Nov. 1, 2012, which is hereby incorporated by reference in its entirety.

### FIELD

This technology relates to methods for washing aquatic animal containment basins and apparatuses thereof.

### BACKGROUND

The problem of washing tanks for containing aquatic animals and their accessories (siphons, partitions, filters, etc.) has been dealt with by implementing washing machines already known in the field of washing small cages for containing laboratory animals (typically rodents) with special and appropriate devices adapted to actuate innovative washing cycles which, by using specific detergents and with the imposition of well-defined parameters, are capable of removing algae, residues of fish food, and above all the various types of bio film that develop on the surfaces of tanks which remain in contact with water for long periods.

Above all, bio-films have been shown to be extremely tenacious and resistant. Their removal ensures that the environment in direct contact with the fish is completely sanitized and free from bacteria and micro-organisms which settle beneath the layer of biofilm itself.

The choice of detergents and the method of use, i.e. the washing cycle actuated by using these detergents, have been determining factors.

### SUMMARY

The procedure according to the present invention thus provides for washing the tanks of aquatic animals by using, in an appropriate washing machine, a solution of alkaline detergent, preferably in aqueous solution at a concentration of 0.8%, in combination with hydrogen peroxide, preferably in a proportion of 30-35%, in 0.5% solution.

The solution of alkaline detergent and hydrogen peroxide in the concentrations described is then placed in the tanks or washing baths of a washing machine, also a subject of the present invention, therefore, for washing, a solution of water and alkaline detergent and hydrogen peroxide is used in the preferred concentrations indicated.

According to a preferred embodiment of the invention, the alkaline detergent is an aqueous solution of potassium hydroxide in a proportion of 20-40%.

The washing cycle according to the present invention then comprises, after the washing step, a step of neutralization of the detergent, which requires the use of an acid-based product to re-establish the desired pH of the residual of washing solution still present in the washing chamber after the washing phase.

According to a best mode to carry out the invention, the neutralizing agent is an acid based product. More preferably, the neutralizing agent is an aqueous solution of phosphoric acid in a proportion of 25%.

The chemical products used for the cycle, both the alkali-based ones and the acid ones, must be completely free from surfactants, phosphates and chlorine, all of which products are extremely damaging to the health of fish.

Other parameters which contribute to the optimum result are the washing-cycle times and the temperatures of the washing bath.

Also a subject of the present invention is the washing machine capable of actuating the present washing cycle.

In particular, for the purpose of controlling times and temperatures of the wash bath, the washing machine according to the present invention comprises a control panel which controls suitable means for regulating the machine so as to control the wash time and temperature, as well as the concentration values of the detergents mentioned above. The data are transmitted to the PLC controller, which has the task of controlling the cycles completely automatically.

Bath temperatures and wash times can have different values depending on the type and the amount of dirt present on the tanks and their accessories.

Another very important aspect in the development of the washing cycle is the step of “neutralization” and “final rinse”.

Neutralization of detergents used in the washing step and non-optimal rinsing, and thus the presence of chemical-product residues on the surfaces of the tanks, is not entirely acceptable in the field of research conducted on fish, constituting a potential risk of disease and mortality, with consequent economic damage and, above all, a deterioration in the results obtainable by the research.

The water present in the tanks, which are hydraulically interconnected, is continuously circulated to filter it. A single tank having significant residues of detergent could contaminate the water in the other tanks connected to the centralized plant, with disastrous consequences.

Hence the need to equip the machines with control systems which can guarantee the replicability of the process developed in the experimental phase to verify the quantities of metered chemical products, both detergents and neutralizers, but also the quantity of water used for the rinsing step.

In particular the rinsing in the washing machine that is the subject of the present invention is carried out using the pressure of the water main which supplies a series of spray nozzles. The quantity of water consumed is determined by the time of the neutralization and rinsing steps and by the mains pressure.

Alternatively, the spray nozzles for rinsing may be supplied by a centrifuge pump supplied from a dedicated tank, therefore the quantity of water used is determined solely by the time of the steps of neutralization and rinsing, the pump pressure being a constant value.

Listed below are the control components which are provided to guarantee actuation of the washing method according to the present invention, ensuring the correct result of washing, neutralization and rinsing of the aquatic cycles, and which distinguish the washing machine according to the present invention from currently known machines.

The washing machine that is the subject of the present invention will—for the purpose of actuating the method of washing which itself is a subject of the present invention—comprise at least:
A washing chamber;
A first supply pump for supplying the alkaline detergent to the washing chamber, with respective flow-meter;
A second supply pump for supplying the hydrogen peroxide to the washing chamber, with respective flow-meter;
A third supply pump for supplying the neutralizing agent to the washing chamber, with respective flow-meter.

Owing to the three dedicated pumps, it is possible to administer detergent and neutralizer to the wash bath by controlling, by means of the flow meters, the quantities of detergent and neutralizer administered respectively to the wash bath and the rinse water.

In a possible configuration, the washing machine according to the present invention will also comprise:
A pressure regulator at the inlet of the supply line of the rinsing circuit;
A pressure switch at the inlet of the supply line of the rinsing circuit;
A flow meter at the inlet of the supply line of the rinsing circuit.

If during the cycle, the controlled parameters do not correspond to the values stipulated in the formula, the cycle is interrupted.

For further clarification, a diagram is provided of the washing machine that is the subject of the present invention and is adapted to carry out the process according to the present invention.

More in particular are presented here, by way of example non-limiting of the present invention, two different types of machine for washing tanks for containing aquatic animals according to the invention.

The first type of machine, indicated as machine TYPE A, provides for the rinsing circuit to be supplied directly at the pressure of the water main.

The second type of machine, indicated as machine TYPE B, provides for the rinsing circuit to receive pressure from a pump, supplied from a reservoir tank and installed at the edge of the actual machine. The machine type B may more in particular be provided with a single or double washing tank. In the drawings provided here by way of example non-limiting of the present invention, a washing machine comprising a single tank is indicated as B1, a machine comprising a double tank is indicated as B2.

### BRIEF DESCRIPTION OF THE DRAWINGS

FIG. 1 shows a scheme of a machine Type A according to the present invention;

FIG. 2 shows a scheme of a machine Type B1 according to the present invention; AND

FIG. 3 shows a scheme of a machine Type B2 according to the present invention.

### DETAILED DESCRIPTION

Regarding the temperatures and the times of the washing steps, as suggested above, these are dependent upon the type and the amount of dirt.

Substantially two cycles are identified, optimized according to the type of washing machine, which are hereinafter illustrated by way of example non-limiting of the present invention and in relation to the diagram of the washing machine which actuates this treatment.

The procedures may comprise different steps indicated by the symbols given in the legend below:

W=washing step

R=rinsing step

N=neutralization step

T=transfer of water during the inflow of neutralizing product

E=vapour extraction step

Washing Machine with Rinsing Circuit Directly Connected to the Water Main (Machine TYPE A).

a) In the case of tanks and accessories that are not excessively dirty, the preferred conditions of washing may be, for example, the following:

W: 600 sec, at 70° C. (158° F.)

N: 15 sec, at 85° C. (185° F.)

R: 50 sec, at 85° C. (185° F.)

E: 90 sec

Concentration of alkaline detergent 0.8%

Concentration of hydrogen peroxide 0.5%

Neutralizing agent with metering pump output 20 l/h at concentration 0.5%.

b) In the case of very dirty tanks and accessories with massive presence of bio-film, a high-temperature cycle is opted for, preferred washing conditions:

W: 1200 sec, at 85° C. (185 ° F.)

N: 15 sec, at 85° C. (185° F.)

R: 50 sec, at 85° C. (185° F.)

E: 90 sec

Alkaline detergent concentration 0.8%

Hydrogen peroxide concentration 0.5%

Neutralizing agent with metering pump output 20 l/h at CONCENTRATION 0.5%

Washing Machine with Double Washing Tank, and Rinsing Tank Fitted with a Centrifuge Pump (TYPE B2).

The washing cycle is performed using a first washing tank (011W1) with the solution based on alkaline product and hydrogen peroxide and a second washing tank (011W2) with the neutralizer-based solution. After the washing step which uses the solution from the first tank (011W1), a first rinse is carried out with a portion of the water contained in the rinsing tank (011R). This step is followed by the neutralization step contained in the second washing tank (011W2) and finally the definitive rinsing is performed.

a) In the case of tanks and accessories that are not excessively dirty, the preferred washing conditions may be, for example, the following:

W: 480 sec, at 70° C. (158° F.)

R1: 15 sec, at 85° C. (185° F.)

N: 240 sec at 85° C. (185° F.)

R2: 30 sec, at 85° C. (185° F.)

Alkaline detergent concentration in the first washing tank 0.8%

Hydrogen peroxide concentration in the first washing tank 0.5%

Neutralizing solution concentration in the second washing tank 0.5%

b) In the case of very dirty tanks and accessories with massive presence of bio-film, a high-temperature cycle is opted for, the preferred washing conditions are, for example, the following:

W: 1800 sec, at 76.6° C. (170° F.)

R1: 15 sec, at 85° C. (185° F.)

N: 240 sec, at 85° C. (185° F.)

R2: 30 sec, at 85° C. (185° F.)

Alkaline detergent concentration in the first washing tank 0.8%

Hydrogen peroxide concentration in the first washing tank 0.5%

Neutralizing solution concentration in the second washing tank 0.5%

Washing Machine Comprising a Single Washing Tank, and a Rinsing Tank Fitted with a Centrifuge Pump (TYPE B1).

The cycle is performed using the washing tank (011W1) with the alkaline product-based solution and hydrogen peroxide. Since it is usually used with machines for washing rodent tanks, the neutralization step performed by injecting the neutralizing product directly into the rinsing circuit is too weak, as demonstrated by experimental tests. With a view to improving the achievable result, it would be possible to increase the neutralization time, but this would be very expensive in economic terms due to the considerable consumption of water and neutralizing product. A more effective neutralization was therefore obtained by appropriately modifying the program for controlling the cycle in the way described below.

After the washing step, a defined volume of water from the rinsing tank programmed in prescription is transferred by the pump (301R) to the rinsing nozzles and by the latter to the low part of the machine (reservoir). The neutralizing product too is transferred into the reservoir by the metering pump, in the quantity necessary to obtain the concentration provided for in the prescription. At this point, the pump for transferring the reservoir (see pump 302), which continues to recirculate the neutralizing solution within the washing chamber for a defined time. At the end of this step, the solution present in the reservoir is discharged and the cycle is completed with the final rinsing step.

a) In the case of tanks and accessories which are not excessively dirty, the preferred washing conditions are the following:

W: 480 sec, at 70° C. (158° F.)

T: 40 sec, at 85° C. (185° F.)

N: 240 sec, at 85° C. (185° F.)

R 30 sec 85° C. (185° F.)

Alkaline detergent concentration 0.8%

Hydrogen peroxide concentration in 0.5%

Neutralizing solution concentration in the reservoir 0.5%

b) In the case of very dirty tanks with massive presence of bio-film high temperature cycle, preferred washing conditions:

W 1800 sec 76.6° C. (170° F.)

T 40 sec 85° C. (185° F.)

N 240 sec 85° C. (185° F.)

R 30 sec 85° C. (185° F.)

Alkaline detergent concentration 0.8%

Hydrogen peroxide concentration in 0.5%

Neutralizing solution concentration in the reservoir 0.5%

Coming now to the advantages of the machines which actuate the washing process that is the subject of the present invention, the type A machine provides for monitoring of the quantity of water used during the neutralization and rinsing steps is monitored continuously using a device for monitoring the output, in particular a flow meter (701/2).

The flow meter checks that, during each step, the machine is interrogated for the quantity of water charged into the cycle, and also that the output remains constant within a predefined tolerance range. This guarantees that variations in mains pressure do not affect the volumes of water charged into the cycle, a typical technical problem which afflicts machines supplied directly from the water supply mains.

The same is true of the flow meters (701, 701/1) installed on the metering pumps, the task of which is to control the consumption of the chemical products used in the process.

Changes in the ambient temperature many produce even sizable changes in the viscosity of the chemical products and detergents, and therefore an operation of the dose-metering pumps based exclusively on the metering time would not guarantee the replicability of the cycle and of the results. For this reason, a flow meter associated with each metering pump is therefore used, so when the quantity of product necessary for achieving the specified concentration has effectively been reached, as measured by the flow meter, the pump will be stopped by the control unit of the machine.

With the type B washing machine, whether it comprises a single (B1) or double (B2) washing tank, the rinsing circuit comprises a centrifuge pump (301R) for supplying the rinsing circuit itself Use of the flow meter on the water line is not necessary in this case.

The pump (301R) of the rinsing line in fact supplies a series of rinsing nozzles the output of which is known and is a function of pump pressure, which is a constant. For this type of machine also, however, flow meters are necessary to measure the quantity of detergent and neutralizer supplied by the metering pumps.

The program for controlling the process of washing aquatic tanks, which is controlled by the control unit of the machine, takes into consideration another important phenomenon linked to the use of hydrogen peroxide.

Hydrogen peroxide is known to be unstable, even at the not excessively high temperatures specified for the washing cycles described above. The hydrogen peroxide solution in fact evolves oxygen, which dissolves in air, changing the original concentration.

In the machine for washing small cages for containing laboratory animals, such as for example rodents, the concentrations of the detergents used are restored at the end of the washing cycle. However, this cannot be done in the machines for washing aquatic tanks that are the subject of the present invention, in that the evaporation of oxygen from the hydrogen peroxide also occurs with the machine closed, or for example during periods of machine inactivity between one washing cycle and another. For this reason, if the concentration of the hydrogen peroxide solution is also re-established at the end of the washing cycle, this concentration could be changed at the start of the new cycle.

In order to avoid this drawback, the control unit of the machine is programmed so as to regulate the dosage of the alkaline product and of the hydrogen peroxide only when the operative executes the command to start the cycle from the control panel. In this way there is the certainty that the cycle starts off with the optimal conditions of concentration of the washing solution. This operating logic is applied both to the initial preparation of the washing solution and to restoration of the concentrations after a cycle.

Another specific technical problem which involves machines for washing aquatic tanks that are the subject of the present invention, but does not affect washing machines of the known type which are used for washing tanks of rodents, consists in the stipulation of the variable “gain”. This parameter gives the possibility of reinforcing the bath after one cycle with the percentage concentration stipulated in the desired original description, but also with a correction factor called precisely this: “gain”. This correction factor takes account of any further dilutions of the concentration of the solution in a particular way for very long washing cycles.

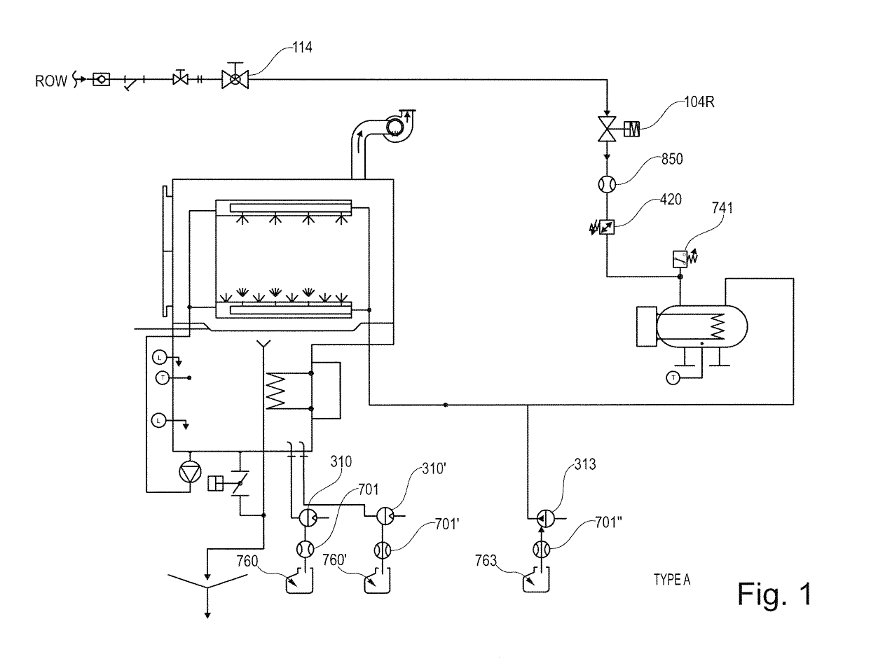

Indication of the Details on FIG. 1, Washing Machine Type A:

| | |
|---|---|
| 114 | RO water incoming interception valve |
| 310′ | Detergent dosage unit |
| 310 | Detergent dosage unit |
| 313 | Neutralizer dosage unit |
| 420 | Pressure regulator |
| 701′ | Flow meter |
| 701″ | Flow meter |
| 701 | Flow meter |
| 741 | Pressure switch |
| 760′ | Minimum detergent level sensor |
| 760 | Minimum detergent level sensor |
| 763 | Minimum neutralizer level sensor |
| 850 | Water meter |
| 104R | Rinse RO water incoming pneumatic valve |
| ROW | RO water |

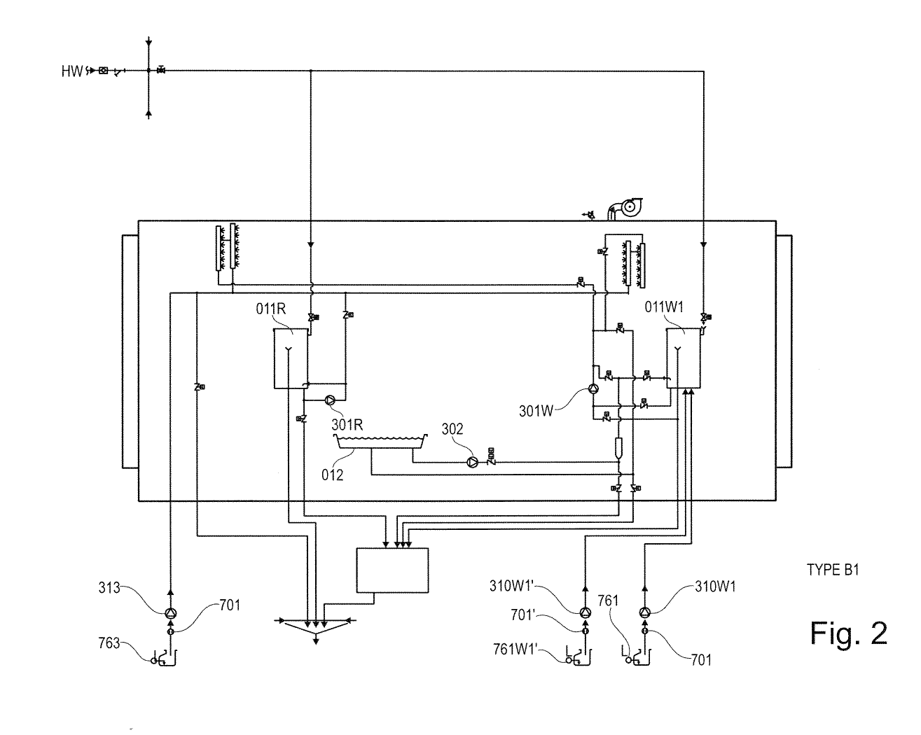

Indication of the Details on FIG. 2, Washing Machine Type B1:

| | |
|---|---|
| HW | Softened water |
| 011R | Rinse tank |
| 011W1 | Wash tank |
| 012 | Water collection tank |
| 301R | Rinse pump |
| 301W | Wash pump |
| 302 | Transfer pump |
| 310W1 | Detergent dosage unit - tank 1 (alkaline detergent) |
| 310W1′ | Detergent dosage unit - tank 1 (Hydrogen peroxide) |
| 313 | Neutralizer dosage unit |
| 761W1 | Minimum detergent level sensor |
| 761W1′ | Minimum detergent level sensor |

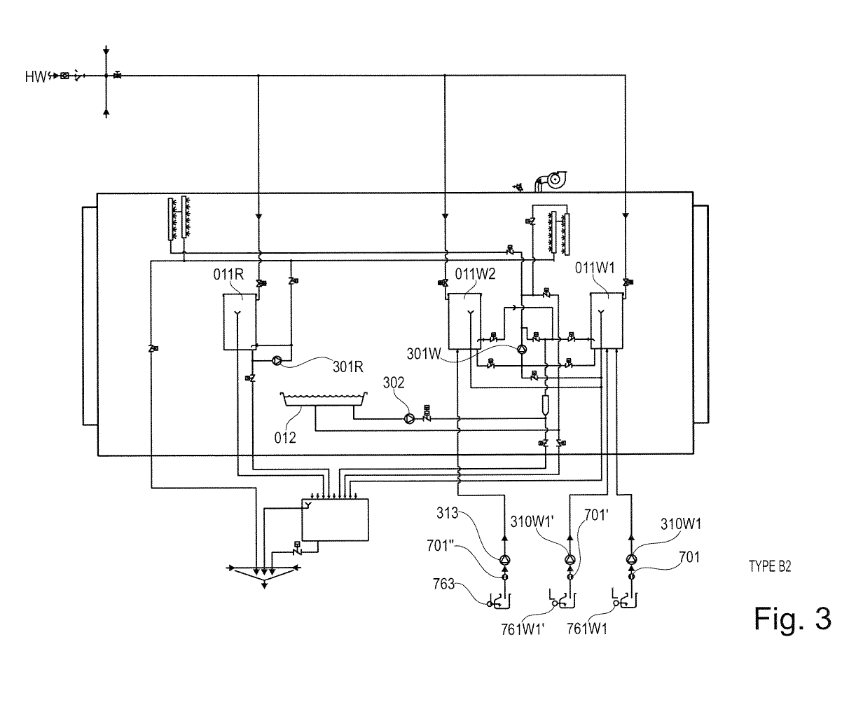

Indication of the Details on FIG. 3, Washing Machine Type B2:

| HW | Softened water |
|---|---|
| 011R | Rinse tank |
| 011W1 | Wash tank 1 |
| 011W2 | Wash tank 2 |
| 012 | Water collection tank |
| 301R | Rinse pump |
| 301W | Wash pump |
| 302 | Transfer pump |
| 310W1 | Detergent dosage unit - tank 1 (alkaline detergent) |
| 310W1′ | Detergent dosage unit - tank 1 (Hydrogen peroxide) |
| 313 | Neutralizer dosage unit |
| 701 | Flow meter |
| 701′ | Flow meter |
| 701″ | Flow meter |
| 761W1 | Minimum detergent level sensor |
| 761W1′ | Minimum detergent level sensor |
| 763 | Minimum detergent level sensor |

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for washing one or more tanks for containing aquatic animals, the method comprising:
inserting one or more tanks for aquatic animals to be washed into a washing chamber of a washing apparatus;
supplying to the washing chamber a washing solution, the washing solution comprising an alkaline detergent in combination with hydrogen peroxide, the alkaline detergent is free from surfactants, phosphates and chlorine;
supplying a neutralizing agent to the washing chamber, the neutralizing agent is free from surfactants, phosphates and chlorine to re-establish a desired pH of a residual washing solution in the washing chamber;
supplying rinsing water to the washing chamber to rinse the tanks.

2. The method for washing tanks for containing aquatic animals according to claim 1, wherein the washing solution is an aqueous solution comprising alkaline detergent at a concentration of 0.8%, in combination with hydrogen peroxide in a proportion of 30-35% in 0.5% solution.

3. The method for washing tanks for containing aquatic animals according to the claim 2, wherein the alkaline detergent is potassium hydroxide.

4. The method for washing tanks for containing aquatic animals according to the claim 3, wherein the alkaline detergent is potassium hydroxide in a proportion of 20-40%.

5. The method for washing tanks for containing aquatic animals according to claim 1, wherein the neutralizing agent is phosphoric acid in aqueous solution.

6. The method for washing tanks for containing aquatic animals according to the claim 5, wherein the phosphoric acid in aqueous solution is in a proportion of 25%.

7. The method for washing tanks for containing aquatic animals according to claim 1, wherein during the washing step the washing solution has a temperature between 60° C. and 85° C.

8. The method for washing tanks for containing aquatic animals according to claim 1, wherein during the rinsing step the rinsing water has a temperature of 85° C.

9. The method for washing tanks for containing aquatic animals according to claim 1, wherein during the neutralizing step, the neutralizing agent is at a temperature of 85° C.

10. A washing apparatus for washing tanks for containing aquatic animals, the apparatus comprising:
at least a washing chamber into which one or more washing tanks are positioned;
at least a first supply pump for supplying an alkaline detergent to the washing chamber, the first supply pump being provided with a first flow-meter for determining the quantity of the alkaline detergent supplied to a washing bath;
at least a second supply pump for supplying hydrogen peroxide to the washing chamber, the second supply pump being provided with a second flow-meter for determining the quantity of the hydrogen peroxide supplied to the washing bath;
at least a third supply pump for supplying neutralizing agent to the washing chamber, the third supply pump being provided with a third flow-meter for determining the quantity of the neutralizing agent supplied.

11. The apparatus according to claim 10 further comprising a rinsing circuit for rinsing the tanks, the neutralizing agent being supplied to the washing chamber by means of the rinsing circuit.

12. The apparatus according to claim 11, wherein the rinsing circuit further comprises:
a pressure regulator at an inlet of the supply line of the rinsing circuit;
a pressure switch at an inlet of the supply line of the rinsing circuit;
a flow meter at an inlet of the supply line of the rinsing circuit.

13. The apparatus according to claim 10 further comprising a programmable control unit configured to detect a concentration of the alkaline detergent and of the neutralizing agent in aqueous washing and neutralizing solutions, respectively, in the washing bath in order to restore the concentration at the end of a washing cycle, the programmable control unit of the washing machine further being able to control one or more of the first supply pump, the second supply pump or the third supply pump on the basis of information provided by the first flow-meter, the second flow-meter, or the third flow meter in order to control the quantities of one or more of the alkaline detergent, the hydrogen peroxide, or the neutralizing solution supplied to the washing chamber.

14. The apparatus according to claim 10 further comprising a rinsing circuit supplied directly by a water main and at a pressure of the water main.

15. The apparatus according to claim 10 further comprising a rinsing circuit comprising at least one tank for rinsing water and receiving pressure from a rinsing pump.
